(19) United States
(12) Patent Application Publication
(10) Pub. No.: US 2015/0227754 A1
(43) Pub. Date: Aug. 13, 2015

(54) RULE-BASED ACCESS CONTROL TO DATA OBJECTS

(71) Applicant: INTERNATIONAL BUSINESS MACHINES CORPORATION, Armonk, NY (US)

(72) Inventors: Gregory J. Boss, Saginaw, MI (US); Andrew R. Jones, Round Rock, TX (US); Charles S. Lingafelt, Durham, NC (US); Kevin C. McConnell, Austin, TX (US); John E. Moore, JR., Brownsburg, IN (US)

(73) Assignee: INTERNATIONAL BUSINESS MACHINES CORPORATION, Armonk, NY (US)

(21) Appl. No.: 14/176,708

(22) Filed: Feb. 10, 2014

(51) Int. Cl. G06F 21/62; G06F 17/30

(52) U.S. Cl. CPC G06F 21/6218; G06F 17/30997

(57) ABSTRACT

Access control functions for data objects include assigning tags to the data objects associated with a client device. The tags represent security attributes. Upon determining an access attempt for one of the data objects has been initiated by a user of the client device, the access control functions include gathering environmental information associated with conditions surrounding the client device, identifying a tag assigned to the one of the data objects, applying access control rules to the environmental information as a function of the corresponding tag, and performing an access-related function with respect to the access attempt based on results of application of the access control rules.

### BACKGROUND

The present disclosure relates to data security, and more specifically, to rule-based access control of data objects.

Sharing computer-based information has become common place with today's technology. Data is ubiquitously transmitted and shared across various communication networks. This information is often put in emails and calendar invitations and is often used to drive meetings and projects. In some cases, multiple information objects are bundled together and shared as a unit. Some of this information may not be designated for public consumption.

### SUMMARY

According to embodiments of the present invention, a method, system, and computer program product are provided. The method includes assigning tags to the data objects associated with a client device. The tags represent security attributes. Upon determining an access attempt for one of the data objects has been initiated by a user of the client device, the method includes gathering environmental information associated with conditions surrounding the client device, identifying a tag assigned to the one of the data objects, applying access control rules to the environmental information as a function of the corresponding tag, and performing an access-related function with respect to the access attempt based on results of application of the access control rules.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a system upon which rule-based access controls may be implemented in accordance with some embodiments; and

FIG. 2 depicts a flow diagram illustrating a process for implementing rule-based access controls in accordance with some embodiments.

### DETAILED DESCRIPTION

In accordance with exemplary embodiments, rule-based access controls are provided that factor in environmental conditions in determining access functions for various data objects. Access controls may include enabling access to a data object, enabling restricted or modified access to a data object, or preventing access to a data object. Based on security attributes assigned to the data objects, in conjunction with the access control rules and environmental conditions, a rendering function (also referred to as access-related function) is determined and implemented with respect to the data object.

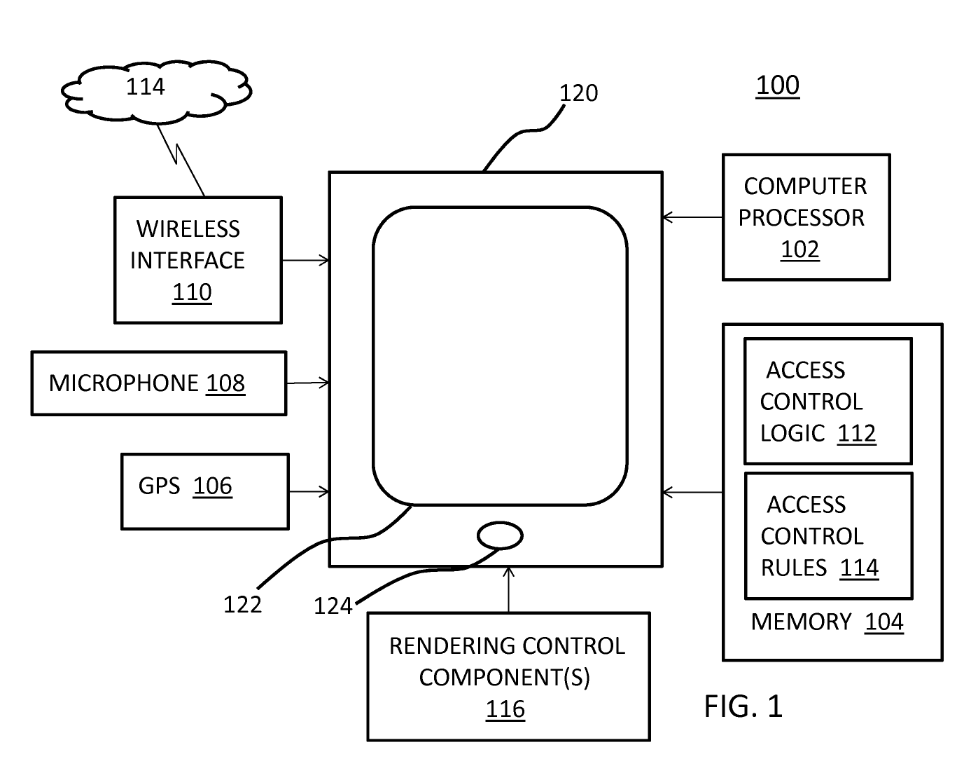

Turning now to FIG. 1, a system upon which rule-based access controls may be implemented will now be described in accordance with an embodiment.

The system 100 includes a client device 120. The client device 120 may be any type of wireless or wireline computer device, such as, but not limited to, a personal computer, laptop, tablet PC, smartphone, or personal digital assistant. The client device 120 includes a computer processor 102 and memory unit 104. The memory unit 104 may store various applications, data files, multimedia content (e.g., digital audio, video, or combination thereof), still images, computer screen shots, or any type of content capable of being stored on the device 120. This content is collectively referred to herein as data objects. The memory unit 104 also stores access control logic 112 and access control rules 114 for facilitating the rule-based access controls, as will be described further herein.

The client device 120 includes input/output (I/O) components. As shown in FIG. 1, for example, a display screen 122, if touchscreen enabled, may serve as an input component for entering data and requests for access to content stored in the memory unit 104. In addition, the input components may include an input control 124 for selectively accessing various functions provided by the client device 120. In a further embodiment, an input component may include a microphone 108 embedded in the client device 120. Output components may include the display screen 122, as well as a speaker (not shown).

The client device 120 also includes a global positioning system (GPS) 106 and a wireless interface 110, both of which may be configured to enable the client device 120 to communicate over one or more networks 114. Where the networks 114 include a satellite network, e.g., the GPS 106 may utilize satellite data to determine the position/location of the client device 120 at a given time.

The wireless interface 110 may include a transceiver for sending and receiving wireless communications. In one embodiment, the transceiver (e.g., antennae and related circuitry) may be configured to communicate via long-range networks, such as one or more of a cellular network, satellite network, terrestrial network, Internet, local area network, intranet, etc., and may further include capabilities to communicate via short-range communications protocols, such as Bluetooth™, Wi-Fi, and Zigbee, to name a few. Thus, the networks 114 may include any one or more of the above network types.

The client device 120 also includes rendering control components 116. The rendering control components 116 receive instructions from the computer processor 102 via the access control logic 112 to perform various rendering functions or controls in response to a user's requests to access data objects in the memory unit 104. The rendering components 116 include various controllers and related circuitry that are capable of modifying presentation of, and/or access to, the data objects. The rendering control components 116 are described further herein.

The client device 120 may include other components, such as a camera, a air pressure sensor, voice and video recognition software, screen sharing software, and an accelerometer, to name a few. The access control logic 112 may receive data from these components for use in determining and implementing a rendering control function by the rendering control components 116, as will be described further herein.

While the above embodiments disclose data objects, access control rules, and access control logic as residing locally on the client device 120, it will be understood that the embodiments are not so limited. For example, in another embodiment, at least a portion of the data objects, access control rules 114, and access control logic 112 may reside on another computer system, e.g., a mainframe computer or server system associated with an enterprise. In this embodiment, the user of the client device 120 may be an employee of the enterprise. In an embodiment, the server system monitors a user's access requests for data objects (stored on the client device 120, the server system, and/or a remote storage location), and applies the access control rules to the requests to determine a rendering function to apply to the access requests.

Access control rules 114 may be configured through the access control logic 112 by an administrator or executive of an enterprise or organization seeking to apply security features to its data. Security attributes are assigned to the data objects, e.g., in the form of tags, and the access control rules 114 are defined and stored in the memory unit 104 and/or a storage location of the enterprise. Security attributes define a level of care that is to be afforded the data objects, and may be based on a level of vulnerability associated with the data objects should they be exposed to an entity outside of the enterprise. These functions may be implemented through a user interface provided by the access control logic 112.

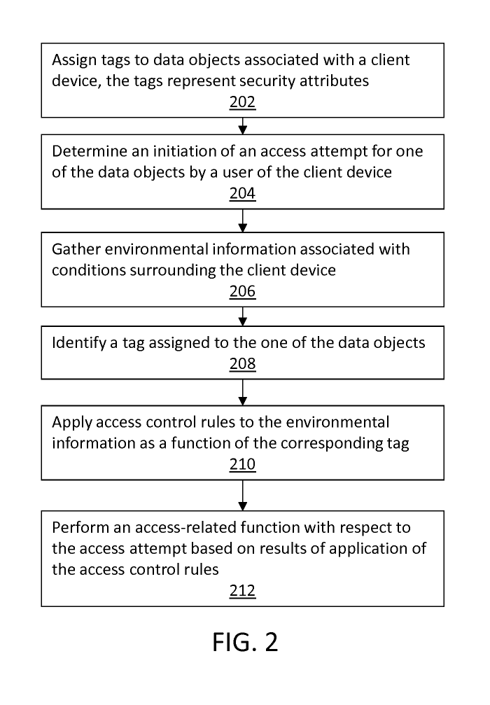

As indicated above, security attributes assigned to data objects are used in conjunction with environmental conditions to determine a rendering function for access requests to data objects. Turning now to FIG. 2, an exemplary process for implementing the rule-based access controls will now be described.

At block 202, a plurality of tags representing security attributes are assigned to data objects in a storage location. In one embodiment, the security attributes may be defined as “low,” “medium,” and “high,” in which low represents the minimum amount of protection to be afforded to a data object, and high represents a greatest amount of protection to be afforded a data object. The access control logic 112 monitors the client device 120 for access requests input by the user of the client device 120.

At block 204, upon determining an access attempt has been made by the user for one of the data objects, the access control logic 112 gathers environmental information associated with conditions surrounding the client device 120. Environmental conditions may be related to a physical location in which the client device 120 resides or may be location-related characteristics associated with the client device 120. For example, location-based environmental information may include a physical address or coordinates that are acquired by GPS 106 or a calendar appointment scheduled into a calendar application of the device 120. Location-related characteristics may include a public versus private location or a location determined by various sensor data. The access control logic 112 may determine that the client device 120 is located in a public place based on noise data acquired from the microphone 108. For example, if a decibel value meets or exceeds a specified value, the access control logic 112 determines that the client device 120 is in a public place. Sensor data, such as air pressure data, acquired via the client device 120 may indicate that the user of the device 120 is in flight. As typically passengers on a plane are in close proximity to other passengers, this data may be useful in determining a rendering function associated with the device 120.

Other environmental information includes the identification of one or more people. For example, using voice recognition software, voice data received via the microphone 108 can be compared with a database of voice data and associated individuals to determine an identification of a voice within range of the client device 120. The access control logic 112 may be configured to store voice data of specified individuals who may be allowed to or prohibited from (e.g., a competitor) receiving data managed by the enterprise. Likewise, video recognition software may be used to identify an individual, e.g., through the camera of the client system 120 which records video information in the vicinity of the client device 120. The access control logic 112 may be configured to compare this recorded video information to stored video or images to identify a person for use in determining a rendering function.

Returning to FIG. 2, at block 208, the access control logic 112 identifies the tag assigned to the data object subject to the access request in order to determine its security attribute.

At block 210, the access control logic 112 applies an access control rule to the environmental information gathered based on the assigned tag. An access control rule applies the tag and the environmental information to the data object to determine a rendering function. A sample access control rule may state:

If the security attribute is low, and the environment reflects the user is in a public place, perform rendering function ‘x.’

At block 212, the access control logic 112 instructs a rendering control function to be implemented via the rendering control components 116 with respect to the access attempt for the data object. The rendering functions may include enabling access to a data object, enabling restricted or modified access to a data object, or preventing access to the data object.

In addition to the environmental factors, the access control logic 112 may also be configured to consider device characteristics of the client device 120 in determining a rendering function. Device characteristics may include a size of the display screen 122 of the device 120, a port for engaging a headset or ear piece, brightness settings, and screen sharing features, to name a few. In this embodiment, the access control rules may include device characteristics in determining a rendering function. For example, access to a data object may be restricted unless the user dims the brightness settings on the display screen. In another example, if the device 120 is on a plane or in a public place, the user may be instructed to modify the screen orientation away from the view of other passengers.

In a further embodiment, the access control logic 112 may be configured to evaluate environmental data, device characteristic data, and data object types in determining a rendering function. For example, an access control rule may determine that the data object is an audio file and, based on determined environmental conditions, restricts access to the audio file until the user plugs in an ear piece. In another example, the data object is a video file and based on determined environmental conditions, the access control logic 112 restricts sharing of the video file to another computer system (e.g., a projector or peer computer).

Various means of rendering controls may be configured and applied according to the level of security associated with a data object. For example, rendering controls may include automatic adjustment of device 120 settings (dimming display screen, lowering volume, shrinking a document, activating a privacy shield, closing a document, etc.) In another embodiment, the rendering controls may include displaying or presenting a message to the user to perform one of the above adjustments) either in conjunction with allowing the access or as a condition of enabling the access. In a further embodiment, the rendering controls may include restricting sharing of the data object, either through messaging tools, conferencing software, or similar methods.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

The descriptions of the various embodiments of the present invention have been presented for purposes of illustration, but are not intended to be exhaustive or limited to the embodiments disclosed. Many modifications and variations will be apparent to those of ordinary skill in the art without department from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), astatic random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to flowchart illustrations and/or block diagrams of methods, apparatus (systems), and computer program products according to embodiments of the invention.

It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention

In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
assigning, via a computer processor, a plurality of tags to data objects associated with a client device, the tags representing security attributes; and
upon determining an access attempt for one of the data objects has been initiated by a user of the client device:
gathering environmental information associated with conditions surrounding the client device;
identifying a tag, of the plurality of tags, assigned to the one of the data objects;
applying an access control rule to the environmental information as a function of the corresponding tag; and
performing, via the computer processor, an access-related function with respect to the access attempt for the one of the data objects based on results of application of the access control rule.

2. The method of claim 1, further comprising:
determining device characteristics of the client device, the device characteristics including at least one of a size of a display screen, a port for engaging a headset, brightness settings, and screen sharing features; and
determining the access-related function based further on the device characteristics.

3. The method of claim 1, wherein the security attributes indicate a level of care afforded to the data objects in preventing exposure of the data objects to individuals outside of an entity.

4. The method of claim 1, further comprising:
gathering environmental information associated with conditions surrounding the client device from within a defined range of the client device.

5. The method of claim 4, wherein the conditions reflect location-based characteristics, the location-based characteristics including a physical location or address, a location in which a plurality of individuals are present within a proximity, and a location indicating the user of the client device is on an aircraft;
wherein the location-based characteristics are derived from at least one of a global positioning system, a scheduled event in a calendar application of the client device, a level of noise detected, and air pressure sensor.

6. The method of claim 4, wherein the conditions reflect an identity of a person who is present and in proximity of the client device, the identity determined by at least one of voice recognition, video recognition, and a scheduled event in a calendar application of the client device.

7. The method of claim 1, wherein the access-related function includes at least one of:
preventing access to the data object;
presenting a message to the client device instructing the user to modify at least one rendering function of the client device;
automatically adjusting at least one setting of a rendering function of the client device.

8. The method of claim 1, wherein the data objects include:
a text file;
an audio file;
a video file;
a multimedia file; and
a screen shot.

9. A system comprising:
a computer processor; and
logic executable by the computer processor, the logic configured to:
assign a plurality of tags to data objects associated with a client device, the tags representing security attributes; and
upon determining an access attempt for one of the data objects has been initiated by a user of the client device:
gather environmental information associated with conditions surrounding the client device;
identify a tag, of the plurality of tags, assigned to the one of the data objects;
apply an access control rule to the environmental information as a function of the corresponding tag; and
perform, via the computer processor, an access-related function with respect to the access attempt for the one of the data objects based on results of application of the access control rule.

10. The system of claim 9, wherein the logic is configured to:
determine device characteristics of the client device, the device characteristics including at least one of a size of a display screen, a port for engaging a headset, brightness settings, and screen sharing features; and
determine the access-related function based further on the device characteristics.

11. The system of claim 9, wherein the security attributes indicate a level of care afforded to the data objects in preventing exposure of the data objects to individuals outside of an entity.

12. The system of claim 9, wherein the logic is configured to:
gather environmental information associated with conditions surrounding the client device from within a defined range of the client device;
wherein the conditions reflect location-based characteristics, the location-based characteristics including a physical location or address, a location in which a plurality of individuals are present within a proximity, and a location indicating the user of the client device is on an aircraft;
wherein the location-based characteristics are derived from at least one of a global positioning system, a scheduled event in a calendar application of the client device, a level of noise detected, and air pressure sensor; and
wherein the conditions reflect an identity of a person who is present and in proximity of the client device, the identity determined by at least one of voice recognition, video recognition, and a scheduled event in a calendar application of the client device.

13. The system of claim 9, wherein the access-related function includes at least one of:
preventing access to the data object;
presenting a message to the client device instructing the user to modify at least one rendering function of the client device;
automatically adjusting at least one setting of a rendering function of the client device.

14. The system of claim 9, wherein the data objects include:
a text file;
an audio file;
a video file;
a multimedia file; and
a screen shot.

15. A computer program product comprising a computer readable storage medium having program instructions embodied thereon, the program instructions executable by a computer processor to cause the computer processor:
assign a plurality of tags to data objects associated with a client device, the tags representing security attributes; and
upon determining an access attempt for one of the data objects has been initiated by a user of the client device:
gather environmental information associated with conditions surrounding the client device;
identify a tag, of the plurality of tags, assigned to the one of the data objects;
apply an access control rule to the environmental information as a function of the corresponding tag; and
perform an access-related function with respect to the access attempt for the one of the data objects based on results of application of the access control rule.

16. The computer program product of claim 15, wherein the program instructions executable by the computer processor cause the computer processor to:
determine device characteristics of the client device, the device characteristics including at least one of a size of a display screen, a port for engaging a headset, brightness settings, and screen sharing features; and
determine the access-related function based further on the device characteristics.

17. The computer program product of claim 15, wherein the security attributes indicate a level of care afforded to the data objects in preventing exposure of the data objects to individuals outside of an entity.

18. The computer program product of claim 15, wherein the program instructions executable by the computer processor cause the computer processor to:
gather environmental information associated with conditions surrounding the client device from within a defined range of the client device;
wherein the conditions reflect location-based characteristics, the location-based characteristics including a physical location or address, a location in which a plurality of individuals are present within a proximity, and a location indicating the user of the client device is on an aircraft;
wherein the location-based characteristics are derived from at least one of a global positioning system, a scheduled event in a calendar application of the client device, a level of noise detected, and air pressure sensor; and
wherein the conditions reflect an identity of a person who is present and in proximity of the client device, the identity determined by at least one of voice recognition, video recognition, and a scheduled event in a calendar application of the client device.

19. The computer program product of claim 15, wherein the access-related function includes at least one of:
preventing access to the data object;
presenting a message to the client device instructing the user to modify at least one rendering function of the client device;
automatically adjusting at least one setting of a rendering function of the client device.

20. The computer program product of claim 15, wherein the data objects include:
a text file;
an audio file;
a video file;
a multimedia file; and
a screen shot.
